(19) United States
(12) Patent Application Publication
(10) Pub. No.: US 2015/0026257 A1
(43) Pub. Date: Jan. 22, 2015

(54) MUSIC BOX

(71) Applicant: Dropbox, Inc., San Francisco, CA (US)

(72) Inventors: Ramesh Balakrishnan, San Francisco, CA (US); Rajeev Nayak, San Francisco, CA (US); Morgan Knutson, Sunnyvale, CA (US)

(73) Assignee: Dropbox, Inc., San Francisco, CA (US)

(21) Appl. No.: 14/054,347

(22) Filed: Oct. 15, 2013

Related U.S. Application Data
(60) Provisional application No. 61/846,915, filed on Jul. 16, 2013.

(51) Int. Cl. H04L 29/08

(52) U.S. Cl. CPC H04L 67/32; H04L 67/104
USPC 709/204

(57) ABSTRACT

Embodiments are provided for a media player. In some embodiments, locally stored media player data is obtained from a first device on at least one of a device setting, a media player setting, and a media player state of a media player module of a web application, the data is stored in a data store of a content management system for a first account, and based on the media player data, locally stored data is selectively synchronized on a second device associated with the first account to provide a continued experience with media on the second device.

### CROSS-REFERENCE TO RELATED APPLICATIONS

The present application claims the benefit of U.S. Provisional Patent Application No. 61/846,915, filed on Jul. 16, 2013, the entire disclosure of which is hereby incorporated herein by this reference.

### FIELD OF THE INVENTION

Various embodiments relate generally to media players.

### BACKGROUND

With both various audio and video players as provided on devices, and as provided as or within web applications accessible on a device, a user may select settings for playback and/or display of content items, interact with content items, and/or otherwise customize their listening and/or viewing experience of the content for the audio/video player. Often times, the settings data is only locally stored on the device and not stored or easily retrieved from a server. Thus, replicating the experience on another device can be a time consuming and tedious process involving both remembering what settings were selected and reselecting all of those various settings on the other device. For example, volume/sound settings selected by the user on a first device for the audio/video player may be locally stored on the device and tedious to retrieve and replicate on another device.

In another example, a user can be presented with a file system hierarchy view on or within an audio and video player where audio files are displayed to a user exactly as the files are stored (e.g., files are listed on the display as stored within a “My Music” directory). Such a file system hierarchy view is neither conducive to the discovery of audio files in other directories nor to the creation and/or display of an ordered list of the audio files. This is because in order to have an ordered view of the files, the user must first manually reorganize (and possibly rename the files so as to be in an alphabetic sequence) within the file system hierarchy to order the files. Furthermore, if the user organizes files within the file system hierarchy as desired, then the same file system storage structure must be reproduced on another device to produce the same view of the files. This makes it difficult to enjoy a custom playlist, with custom playback properties on any of the user's other devices without retracing all of her steps in creating it on each separate device.

Similarly, if the user wants to have the same queue for playback of audio files on two or more devices, then the user must reproduce the queue by selecting the same files for playback, in the same order, and with the same audio player settings, on each device. Accordingly, there is a need to synchronize data across various devices to ensure uniformity of playback and content display on all of such devices as may be desired by a user.

### SUMMARY

Embodiments are provided for a media player. In some embodiments, locally stored media player data is obtained from a first device on at least one of a device setting, a media player setting, and a media player state of a media player module of a web application, the data is stored in a data store of a content management system for a first account, and based on the media player data, locally stored data is selectively synchronized on a second device associated with the first account to provide a continued experience with media on the second device.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 is an exemplary system for a music box in accordance with some embodiments of the invention;

FIG. 2A is an exemplary flowchart for a music box in accordance with some embodiments of the invention;

FIG. 2B is an exemplary flowchart for a music box in accordance with some embodiments of the invention;

FIG. 3 is an exemplary flowchart for a music box in accordance with some embodiments of the invention;

FIG. 4 is an exemplary flowchart for a music box in accordance with some embodiments of the invention;

FIG. 5 is an exemplary user interface for a music box in accordance with some embodiments of the invention;

FIG. 6 is an exemplary user interface for a music box in accordance with some embodiments of the invention; and

FIG. 7 is an exemplary user interface for a music box in accordance with some embodiments of the invention.

### DETAILED DESCRIPTION OF THE DISCLOSURE

Methods, systems, and computer readable mediums for features of media players are provided. A media player is computer software that may be used to view collections of content items and playback of content items (e.g., media files, including audio and/or video files). Media players can be implemented as a stand-alone application executing on a device, a module of a stand-alone application, and/or a module of a web application (e.g., thin and/or thick client applications) displayed with a browser. Media player user interfaces and devices that execute the media player software offer settings both for organization and/or playback of media for selection by the user, and the selected settings can be stored locally on a first device. The state of the media player during presentation of media and/or playback may also be recorded and locally stored. Locally stored data on device settings, media player settings, and media player state may be obtained from the first device, and the locally stored data may be synchronized between devices to resume an experience with the media player and/or media. In some embodiments, the locally stored data for the media player may serve as a guide for determining content items to cache on devices supported by a user account.

By way of example, a web application may be implemented as a thin client web application with an HTML5 audio player module. The HTML5 audio player may utilize local storage objects and session storage objects which may be stored with the browser to record settings and/or state information for the media player. HTML5 locally stored object data may not be sent to the web server with every request, and instead, it may be sent when specifically requested. Locally stored data including, but not limited to, browser local storage objects, browser session storage object, cookies, device settings, information on cached data, any transient data stored for execution of the client application that may not be stored at a server, and/or any combination thereof, may be obtained from a first device and stored with the content management system for a user account. The locally stored data may be selectively synchronized with locally stored data on a second device to allow for continued playback of media content items for the account and/or shared with another user account. The locally stored data may serve as a guide for synchronizing and/or preemptively caching content items on devices associated with the user account. In particular, locally stored data indicating content items within a queue and/or cached on a first device for a queue may be sent to one or more other devices associated with the user account to be cached.

In some embodiments, a collection of content or content from the displayed collection that is moved within the file system hierarchy and/or otherwise modified on the first device may be selectively synchronized and/or cached based on settings and/or state indicated in locally stored media player data on the first and/or the second device. For example, media content items that have been moved within a file system hierarchy and/or modified may be synchronized between devices and/or cached on devices associated with an account, when the media player data indicates recent interaction with content of a collection. By way of further example, the media content items within a queue for playback and/or were requested for display in a customized view for the account may serve as an indicator for what may be desired on another device associated with the account, and modified collections with content items within the queue may be prioritized for caching and/or synchronization on other devices associated with the account.

In further embodiments, a view of content (e.g., display of a virtual collection of media content items) may be requested by a user with links to the particular files and presented for display on the first device. The view may be customized by the user (such as by ordering and/or filtering) for a collection of content items and displayed on the first device. The customized view may be stored as transient data that is obtained and subsequently stored with the content management system. The transient data may be synchronized between devices to provide a continued experience with a media player, when a user moves to a different device.

Synchronization is a process for ensuring that content items in two or more locations are updated in accordance with particular rules. By way of example, content items may be updated and/or copied in two locations (e.g., on two devices) to ensure that the content items are identical. Continuing with the example, content items may be updated by copying an entire content item to a second device, updating a portion of a content item at the second device, providing a difference vector or indicator between content items to replicate the content item on the second device, and/or any other method for updating a content item.

In some embodiments, contents of a cache of a first device may be pushed (and/or pulled at request of a second device) to the cache of the second device so as to replicate on a cache in the second device the contents of the cache on the first device. The caches of the two devices may be so synchronized so as to enable retrieval of the same content items from the respective caches and thus provide a continued seamless experience for the media player across both (or more) devices. The content items of the respective caches may be updated and/or copied to ensure identical content items may be found on the two devices.

For purposes of description and simplicity, methods, systems and computer readable mediums will be described for a content storage and management service, and in particular, a media player. However, the terms “content storage service” and “content management system” are used herein to refer broadly to a variety of storage providers and management service providers as well as handling a wide variety of types of content, files, portions of files, and/or other types of data. Those with skill in the art will recognize that the methods, systems, and mediums described may be used for a variety of storage providers/services and types of content, files, portions of files, and/or other types of data.

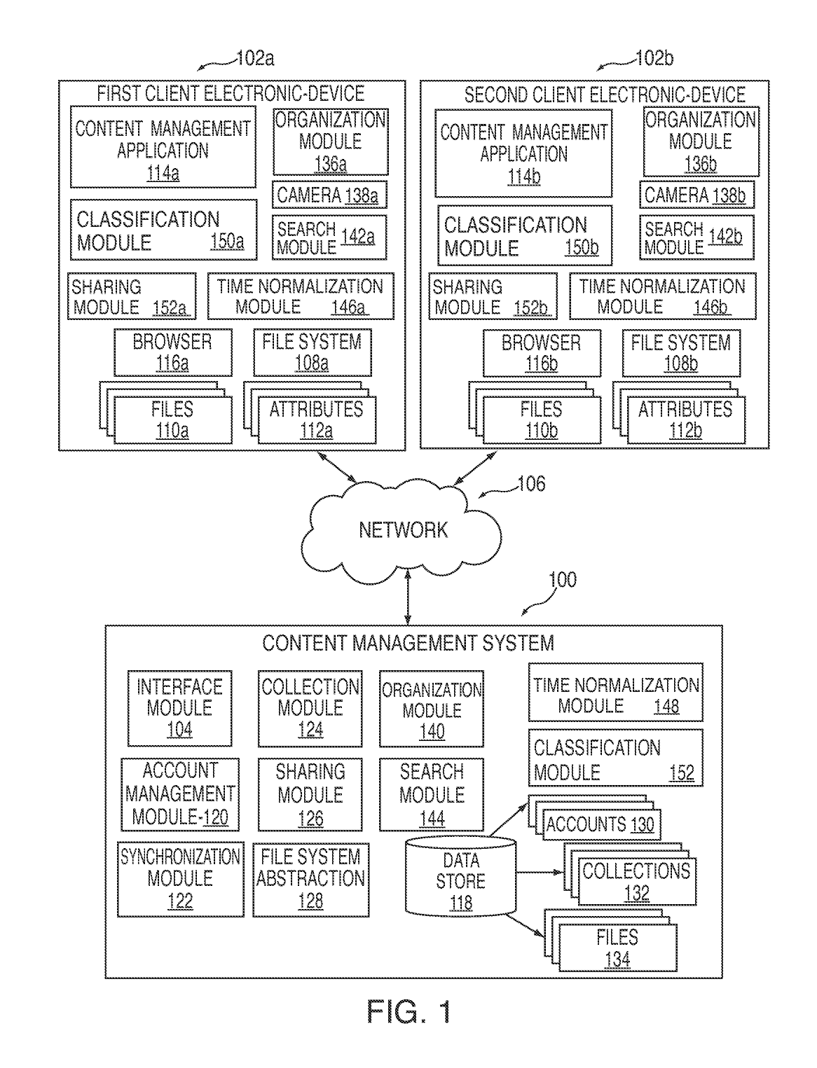

FIG. 1 is an exemplary system for a music box in accordance with some embodiments of the invention. A music box is an implementation of a media player that is used with a content management system. Elements in FIG. 1, including, but not limited to, first client electronic device 102a, second client electronic device 102b, and content management system 100 may communicate by sending and/or receiving data over network 106. Network 106 may be any network, combination of networks, or network devices that can carry data communication. For example, network 106 may be any one or any combination of LAN (local area network), WAN (wide area network), telephone network, wireless network, point-to point network, star network, token ring network, hub network, or any other configuration.

Network 106 can support any number of protocols, including but not limited to TCP/IP (Transfer Control Protocol and Internet Protocol), HTTP (Hypertext Transfer Protocol), WAP (wireless application protocol), etc. For example, first client electronic device 102a and second client electronic device 102b (collectively 102) may communicate with content management system 100 using TCP/IP, and, at a higher level, use browser 116 to communicate with a web server (not shown) at content management system 100 using HTTP. Examples of implementations of browser 116, include, but are not limited to, Google Inc. Chrome™ browser, Microsoft Internet Explorer®, Apple Safari®, Mozilla Firefox, and Opera Software Opera.

A variety of client electronic devices 102 can communicate with content management system 100, including, but not limited to, desktop computers, mobile computers, mobile communication devices (e.g., mobile phones, smart phones, tablets), televisions, set-top boxes, and/or any other network enabled device. Although two client electronic devices 102a and 102b are illustrated for description purposes, those with skill in the art will recognize that any number of devices may be used and supported by content management system 100. Client electronic devices 102 may be used to create, access, modify, and manage files 110a and 110b (collectively 110) (e.g. files, file segments, images, etc.) stored locally within file system 108a and 108b (collectively 108) on client electronic device 102 and/or stored remotely with content management system 100 (e.g., within data store 118). For example, client electronic device 102a may access file 110b stored remotely with data store 118 of content management system 100 and may or may not store file 110b locally within file system 108a on client electronic device 102a. Continuing with the example, client electronic device 102a may temporarily store file 110b within a cache (not shown) locally within client electronic device 102a, make revisions to file 110b, and the revisions to file 110b may be communicated and stored in data store 118 of content management system 100. Optionally, a local copy of the file 110a may be stored on client electronic device 102a.

Client devices 102 may capture, record, and/or store content items, such as image files 110. Client devices 102 may have a camera 138 (e.g., 138a and 138b) to capture and record digital images and/or videos. For example, camera 138 may capture and record images and store metadata with the images. Metadata may include, but is not limited to, the following: creation time timestamp, geolocation, orientation, rotation, title, and/or any other attributes or data relevant to the captured image.

Metadata values may be stored as attribute 112 name-value pairs, tag-value pairs, and/or any other method to associate the metadata with the file and easily identify the type of metadata. In some embodiments, attributes 112 may be tag-value pairs defined by a particular standard, including, but not limited to, Exchangeable Image File Format (Exif), JPEG File Interchange Format (Jfif), and/or any other standard.\

A time normalization module 146 (e.g., 146a and 146b) may be used to normalize dates and times stored with a content item. An example of time normalization is provided in U.S. patent application Ser. No. 13/888,118, entitled “Date and Time Handling,” filed on May 6, 2013, which claims the benefit of U.S. Provisional Patent Application No. 61/801,318, entitled “Date and Time Handling,” filed on Mar. 15, 2013, both of which are incorporated herein by reference in their entirety. The time normalization module 146, counterpart time normalization module 148, and/or any combination thereof may be used to normalize dates and times stored for content items. The normalized times and dates may be used to sort, group, perform comparisons, perform basic math, and/or cluster content items.

An organization module 136 (e.g., 136a and 136b) may be used to organize content items (e.g., image files) into clusters, organize content items to provide samplings of content items for display within user interfaces, and/or retrieve organized content items for presentation. An example of organization is described in U.S. patent application Ser. No. 13/888,186, entitled “Presentation and Organization of Content,” filed on May 6, 2013, which claims the benefit of U.S. Provisional Patent Application No. 61/794,184, entitled “Presentation and Organization of Content,” filed on Mar. 15, 2013, both of which are incorporated herein by reference in their entirety.

The organization module 136 may utilize any clustering algorithm. The organization module 136 may be used to identify similar images for clusters in order to organize content items for presentation within user interfaces on devices 102 and content management system 100. Similarity rules may be defined to create one or more numeric representations embodying information on similarities between each of the content items in accordance with the similarity rules. The organization module 136 may use the numeric representation as a reference for similarity between content items in order to cluster the content items.

In some embodiments, content items may be organized into clusters to aid with retrieval of similar content items in response to search requests. For example, organization module 136a may identify first and second images are similar and may be group the images together in a cluster. Organization module 136a may process image files to determine clusters independently or in conjunction with counterpart organization module (e.g., 140 and/or 136b). In other embodiments, organization module 136a may only provide clusters identified with counterpart organization modules (e.g., 140 and/or 136b) for presentation. Continuing with the example, processing of image files to determine clusters may be an iterative process that is executed upon receipt of new content items and/or new similarity rules.

In some embodiments, a search module 142 on client device 102 is provided with counterpart search module 144 on content management system 144 to support search for content items. A search request may be received by search module 142 and/or 144 that requests a content item. In some embodiments, the search may be handled by searching metadata and/or attributes assigned to content items during the provision of management services. For example, cluster markers stored with images may be used to find images by date. In particular, cluster markers may indicate an approximate time or average time for the images stored with the cluster marker in some embodiments, and the marker may be used to speed the search and/or return the search results with the contents of the cluster with particular cluster markers.

Files 110 managed by content management system 100 may be stored locally within file system 108 of respective devices 102 and/or stored remotely within data store 118 of content management system 100 (e.g., files 134 in data store 118). Content management system 100 may provide synchronization of files managed by content management system 100. Attributes 112a and 112b (collectively 112) or other metadata may be stored with files 110. For example, a particular attribute may be stored with the file to track files locally stored on client devices 102 that are managed and/or synchronized by content management system 100. In some embodiments, attributes 112 may be implemented using extended attributes, resource forks, or any other implementation that allows for storing metadata with a file that is not interpreted by a file system. In particular, an attribute 112a and 112b may be a content identifier for a file. For example, the content identifier may be a unique or nearly unique identifier (e.g., number or string) that identifies the file.

By storing a content identifier with the file, a file may be tracked. For example, if a user moves the file to another location within the file system 108 hierarchy and/or modifies the file, then the file may still be identified within the local file system 108 of a client device 102. Any changes or modifications to the file identified with the content identifier may be uploaded or provided for synchronization and/or version control services provided by the content management system 100.

A stand-alone content management application 114a and 114b (collectively 114), client application, and/or third-party application may be implemented to provide a user interface for a user to interact with content management system 100. Content management application 114 may expose the functionality provided with content management interface 104 and accessible modules for device 102. Web browser 116a and 116b (collectively 116) may be used to display a web page front end for a client application that can provide content management 100 functionality exposed/provided with content management interface 104.

Content management system 100 may allow a user with an authenticated account to store content, as well as perform management tasks, such as retrieve, modify, browse, synchronize, and/or share content with other accounts. Various embodiments of content management system 100 may have elements, including, but not limited to, content management interface module 104, account management module 120, synchronization module 122, collections module 124, sharing module 126, file system abstraction 128, data store 118, and organization module 140. The content management service interface module 104 may expose the server-side or back end functionality/capabilities of content management system 100. For example, a counter-part user interface (e.g., stand-alone application, client application, etc.) on client electronic devices 102 may be implemented using content management service interface 104 to allow a user to perform functions offered by modules of content management system 100. In particular, content management system 100 may have an organization module 140 for identifying similar content items for clusters and samples of content items for presentation within user interfaces.

The user interface offered on client electronic device 102 may be used to create an account for a user and authenticate a user to use an account using account management module 120. The account management module 120 of the content management service may provide the functionality for authenticating use of an account by a user and/or a client electronic device 102 with username/password, device identifiers, and/or any other authentication method. Account information 130 can be maintained in data store 118 for accounts. Account information may include, but is not limited to, personal information (e.g., an email address or username), account management information (e.g., account type, such as “free” or “paid”), usage information, (e.g., file edit history), maximum storage space authorized, storage space used, content storage locations, security settings, personal configuration settings, content sharing data, etc. An amount of content management may be reserved, allotted, allocated, stored, and/or may be accessed with an authenticated account. The account may be used to access files 110 within data store 118 for the account and/or files 110 made accessible to the account that are shared from another account. Account module 120 can interact with any number of other modules of content management system 100.

An account can be used to store content, such as documents, text files, audio files, video files, etc., from one or more client devices 102 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

Content items (e.g., files 110) can be stored in data store 118. Data store 118 can be a storage device, multiple storage devices, or a server. Alternatively, data store 118 can be cloud storage provider or network storage accessible via one or more communications networks. Content management system 100 can hide the complexity and details from client devices 102 by using a file system abstraction 128 (e.g., a file system database abstraction layer) so that client devices 102 do not need to know exactly where the content items are being stored by the content management system 100. Embodiments can store the content items in the same folder hierarchy as they appear on client device 102. Alternatively, content management system 100 can store the content items in various orders, arrangements, and/or hierarchies. Content management system 100 can store the content items in a network accessible storage (SAN) device, in a redundant array of inexpensive disks (RAID), etc. Content management system 100 can store content items using one or more partition types, such as FAT, FAT32, NTFS, EXT2, EXT3, EXT4, ReiserFS, BTRFS, and so forth.

Data store 118 can also store metadata describing content items, content item types, and the relationship of content items to various accounts, folders, collections, or groups. The metadata for a content item can be stored as part of the content item and/or can be stored separately. Metadata can be store in an object-oriented database, a relational database, a file system, or any other collection of data. In one variation, each content item stored in data store 118 can be assigned a system-wide unique identifier.

Data store 118 can decrease the amount of storage space required by identifying duplicate files or duplicate chunks of files. Instead of storing multiple copies, data store 118 can store a single copy of a file 134 and then use a pointer or other mechanism to link the duplicates to the single copy. Similarly, data store 118 can store files 134 more efficiently, as well as provide the ability to undo operations, by using a file version control that tracks changes to files, different versions of files (including diverging version trees), and a change history. The change history can include a set of changes that, when applied to the original file version, produce the changed file version.

Content management system 100 can be configured to support automatic synchronization of content from one or more client devices 102. The synchronization can be platform independent. That is, the content can be synchronized across multiple client devices 102 of varying type, capabilities, operating systems, etc. For example, client device 102a can include client software, which synchronizes, via a synchronization module 122 at content management system 100, content in client device 102 file system 108 with the content in an associated user account. In some cases, the client software can synchronize any changes to content in a designated folder and its sub-folders, such as new, deleted, modified, copied, or moved files or folders. In one example of client software that integrates with an existing content management application, a user can manipulate content directly in a local folder, while a background process monitors the local folder for changes and synchronizes those changes to content management system 100. In some embodiments, a background process can identify content that has been updated at content management system 100 and synchronize those changes to the local folder. The client software can provide notifications of synchronization operations, and can provide indications of content statuses directly within the content management application. Sometimes client device 102 may not have a network connection available. In this scenario, the client software can monitor the linked folder for file changes and queue those changes for later synchronization to content management system 100 when a network connection is available. Similarly, a user can manually stop or pause synchronization with content management system 100.

A user can also view or manipulate content via a web interface generated and served by user interface module 104. For example, the user can navigate in a web browser to a web address provided by content management system 100. Changes or updates to content in the data store 118 made through the web interface, such as uploading a new version of a file, can be propagated back to other client devices 102 associated with the user's account. For example, multiple client devices 102, each with their own client software, can be associated with a single account and files in the account can be synchronized between each of the multiple client devices 102.

Content management system 100 can include sharing module 126 for managing sharing content and/or collections of content publicly or privately. Sharing module 126 may manage sharing independently or in conjunction with counterpart sharing module (e.g., 152a and 152b). Sharing content publicly can include making the content item and/or the collection accessible from any computing device in network communication with content management system 100. Sharing content privately can include linking a content item and/or a collection in data store 118 with two or more user accounts so that each user account has access to the content item. The sharing can be performed in a platform independent manner. That is, the content can be shared across multiple client devices 102 of varying type, capabilities, operating systems, etc. The content can also be shared across varying types of user accounts. In particular, the sharing module 126 can be used with the collections module 124 to allow sharing of a virtual collection with another user or user account. A virtual collection may be a grouping of content identifiers that may be stored in various locations within file system of client device 102 and/or stored remotely at content management system 100.

The virtual collection for an account with a file storage service is a grouping of one or more identifiers for content items (e.g., identifying content items in storage). An example of virtual collections is provided in U.S. patent application Ser. No. 14/054,103, entitled “Systems and Methods for Presenting Content Items in a Collections View,” filed on Oct. 15, 2013, which claims the benefit of U.S. Provisional Patent Application No. 61/750,791, entitled “Presenting Content Items in a Collections View,” filed on Jan. 9, 2013, both of which are incorporated herein by reference in their entirety. The virtual collection is created with the collection module 124 by selecting from existing content items stored and/or managed by the file storage service and associating the existing content items within data storage (e.g., associating storage locations, content identifiers, or addresses of stored content items) with the virtual collection. By associating existing content items with the virtual collection, a content item can be designated as part of the virtual collection without having to store (e.g., copy and paste the content item file to a directory) the content item in another location within data storage in order to place the content item in the collection.

In some embodiments, content management system 100 can be configured to maintain a content directory or a database table/entity for content items where each entry or row identifies the location of each content item in data store 118. In some embodiments, a unique or a nearly unique content identifier may be stored for each content item stored in the data store 118.

Metadata can be stored for each content item. For example, metadata can include a content path that can be used to identify the content item. The content path can include the name of the content item and a folder hierarchy associated with the content item (e.g., the path for storage locally within a client device 102). In another example, the content path can include a folder or path of folders in which the content item is placed as well as the name of the content item. Content management system 100 can use the content path to present the content items in the appropriate folder hierarchy in a user interface with a traditional hierarchy view. A content pointer that identifies the location of the content item in data store 118 can also be stored with the content identifier. For example, the content pointer can include the exact storage address of the content item in memory. In some embodiments, the content pointer can point to multiple locations, each of which contains a portion of the content item.

In addition to a content path and content pointer, a content item entry/database table row in a content item database entity can also include a user account identifier that identifies the user account that has access to the content item. In some embodiments, multiple user account identifiers can be associated with a single content entry indicating that the content item has shared access by the multiple user accounts.

To share a content item privately, sharing module 126 can be configured to add a user account identifier to the content entry or database table row associated with the content item, thus granting the added user account access to the content item. Sharing module 126 can also be configured to remove user account identifiers from a content entry or database table rows to restrict a user account's access to the content item. The sharing module 126 may also be used to add and remove user account identifiers to a database table for virtual collections.

To share content publicly, sharing module 126 can be configured to generate a custom network address, such as a uniform resource locator (URL), which allows any web browser to access the content in content management system 100 without any authentication. To accomplish this, sharing module 126 can be configured to include content identification data in the generated URL, which can later be used to properly identify and return the requested content item. For example, sharing module 126 can be configured to include the user account identifier and the content path in the generated URL. Upon selection of the URL, the content identification data included in the URL can be transmitted to content management system 100 which can use the received content identification data to identify the appropriate content entry and return the content item associated with the content entry.

To share a virtual collection publicly, sharing module 126 can be configured to generate a custom network address, such as a uniform resource locator (URL), which allows any web browser to access the content in content management system 100 without any authentication. To accomplish this, sharing module 126 can be configured to include collection identification data in the generated URL, which can later be used to properly identify and return the requested content item. For example, sharing module 126 can be configured to include the user account identifier and the collection identifier in the generated URL. Upon selection of the URL, the content identification data included in the URL can be transmitted to content management system 100 which can use the received content identification data to identify the appropriate content entry or database row and return the content item associated with the content entry or database row.

In addition to generating the URL, sharing module 126 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 126 can be configured to change the value of the flag to 1 or true after generating a URL to the content item.

In some embodiments, sharing module 126 can also be configured to deactivate a generated URL. For example, each content entry can also include a URL active flag indicating whether the content should be returned in response to a request from the generated URL. For example, sharing module 126 can be configured to only return a content item requested by a generated link if the URL active flag is set to 1 or true. Changing the value of the URL active flag or Boolean value can easily restrict access to a content item or a collection for which a URL has been generated. This allows a user to restrict access to the shared content item without having to move the content item or delete the generated URL. Likewise, sharing module 126 can reactivate the URL by again changing the value of the URL active flag to 1 or true. A user can thus easily restore access to the content item without the need to generate a new URL.

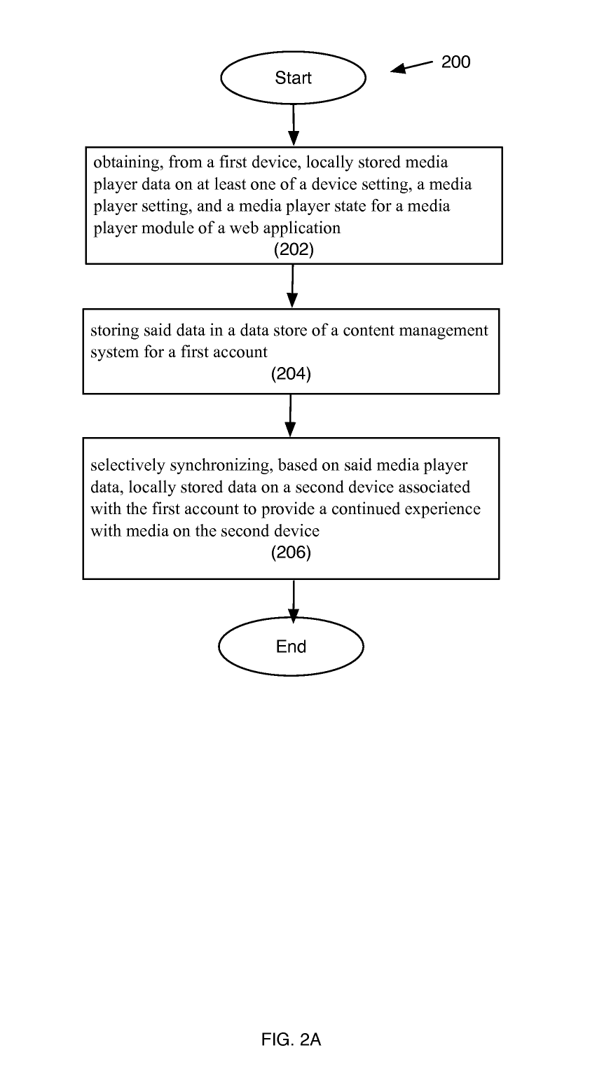

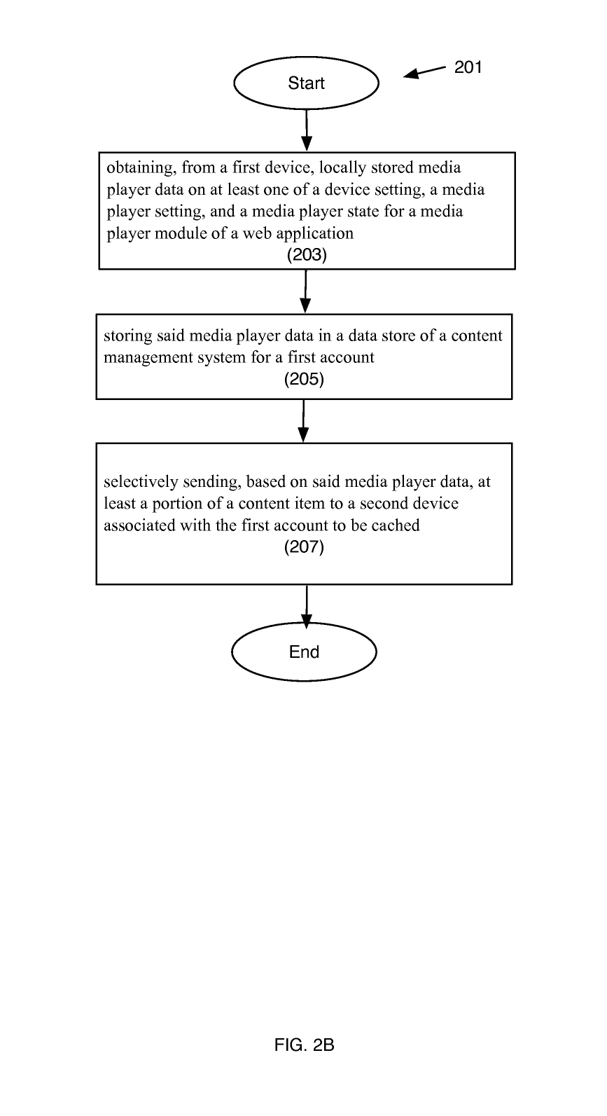

FIG. 2A is an exemplary flowchart for a music box in accordance with some embodiments of the invention. Flowchart 200 describes a media player, in particular, synchronizing locally stored data to replicate, or provide a continuation of a user audio experience (e.g., in regards to presentation and/or playback of media) when a user moves from using a media player on one device to using a similar media player on another device, and/or a user having an account with a content management system sharing their customized media player settings/state with another user account of the content management system. Content management application 114 and/or a web application displayed using web browser 116 of client device 102 may expose the functionality of the media player using interface 104, the synchronization module 122 to synchronize data, sharing module 126 and 142, and other modules of the content management system 100.

Synchronization module 122 may be used to synchronize locally stored data between a first device 102a and a second device 102b and/or ensure local data is synchronized on devices supporting different accounts when local data is shared. Requests for synchronization made from device 102 using the user interface of content management application 114 and/or a web application displayed using browser 116 may be handled by synchronization module 122. Device settings, media player settings, media player state, media content presentation information, and/or media content files and storage structure may be synchronized to ensure that an experience (e.g., view of media, playback of content) with media and/or a media player may be continued on a second device and/or with a second account.

Continuing with reference to FIG. 2A, locally stored media player data on a first device may be obtained (202), such as, for example, a device setting, a media player setting, and/or a media player state (e.g., a module of a web application). Media player settings and state may be recorded in local storage objects, cookies, session storage objects, a cache, files, and/or any other storage format for data used by an application to track settings and state. Settings and state of a media player refers to data values stored for execution of the media player. Settings refers to particular default options and/or options selected by a user for execution of the media player (e.g., volume, selected playlist, selection of songs in a queue, etc.). State refers to data stored reflecting the current execution of the media player (e.g., time or position within a queue of media files, time played or time left to play of a media file, a shuffle seed, etc.). By way of example, the following is pseudocode for a storage object:

var object={‘volumeSetting’=0.10,‘queueFileState’=2,‘mediaFileMinuteState’=1}.

As shown with “object,” a volume is set at “0.1,” the queue state is on the third song (e.g., with song 0 as the first song, song 1 as the second song), and the media file playing is on minute “1.”

The objects may be serialized to translate the data structure and/or the state of the object into a format, such as data written to a file, which may be easily obtained and stored. The serialized object may then be used to create a new object that is identical to, or similar to, the original object. Locally stored data, such as device settings and cached data, may also be obtained using available operating system interface calls, browser interface calls, and/or stored in files that may be synchronized.

Locally stored media player data may include, but is understood not to be limited to, the following: a volume setting, a treble setting, an equalization setting, a cross fade setting, a shuffle queue of content items (e.g., media files), a shuffle seed, a position within a content item (e.g., media file), a position within a queue of content items (e.g., media files), a queue of media files, a sort order for media files, a play head, a beats per minute (bpm) calculation for a content item, a log of events, and/or any other locally stored data for ensuring a continued experience with media. For example, volume settings may be stored in a local storage object and/or session storage object as well as locally stored for the device volume.

In some embodiments, locally stored data may be transient data that is created within an application session and may not ordinarily be sent for storage in the data store during execution of the media player. The transient data may be selected to provide customized presentation of content and/or execution of the media player during a session on the device for the user. For example, a user may customize a view of content items during the application session by executing a query across content items, selecting a particular sort order, and/or select particular content items, and the data on the customized view may be saved locally and not provided for storage in the data store. By way of further example, the user may filter content items within a playlist, a view, a virtual collection, and/or any other set of content items by artist, play count, selected favorites, and/or any other metadata associated with the content items within an application session, and locally stored data on the view and metadata filter stored during the session may be stored and later synchronized to replicate the same view on another device and/or for a different account. In another example, a log of session data and/or events that occur with the application executing while offline (e.g., with no network access and/or no ability to communicate with the data store or content management system 100) may be stored locally. Events may be interactions with content items requested by the user via the media player interface.

Local storage and session storage objects may be serialized and the serialized data may be stored in a particular directory of the first device for the content management system 100 to identify and obtain. Interface function calls (e.g., operating system interface calls, device driver interface calls) may be used to obtain the device settings from the first device. The device settings and media player settings may be used in conjunction with any data stored with content management system 100 to provide a continued experience with media on a device and, in this example, to determine a volume for the second device that is consistent with an actual volume produced by the device with the combined settings for the media player and the device on the first device.

In another example, information on a queue of media content items for playback with the media player may be obtained from locally stored data. A file containing locally stored data on the queue may be synchronized between the first and the second device, and the media player on the second device can use the synchronized data on the queue to continue playback of the queue of media files. By way of example, a serialized locally stored object from the first device may be used to create a locally stored object on the second device. With stored local data on a position within the queue and/or media file, playback may continue at or near to the same place in the queue and/or content item for the user of the first device. Information on the contents of a current queue may be used to order the synchronization of media files between devices. For example, media files for media within the current queue may by prioritized to be synchronized over or before other data for synchronization.

The locally stored data may be stored in the data store 118 of the content management system 100 for a first user account (204). The locally stored data for one or more devices may be stored for an account, and the user may be able to select to resume the presentation and/or the playback of media from a particular device and/or time. The user may be presented with the option to resume play and presentation from all devices supported with the account. The user may be prompted and a display may be provided of locally stored data for a particular device at a particular date and time. A sampling of media items within the queue or a name for an ordering of media items may be presented to aid the user's memory in selection of locally stored data to have restored and/or replicated for another device and/or another account.

The stored data may be selectively synchronized with locally stored data on a second device associated with the first account to provide continued playback of media on the second device with the at least one of the device setting, the media player setting, and the media player state (206). The second device may be associated with the first account by being a device used by the first user account and/or the first user account may share locally stored data with another account that uses the device. By allowing for the locally stored data to be synchronized with another device and/or for an account, a user can share and/or resume an experience with media. For example, a user can resume play of a queue with the same device settings from the first device on the second device.

In another example, another account can resume the play of the queue with the settings from the first device are shared with the second account. In the case of a first user account sharing an experience with a second user account, the queue may be populated only with media accessible with the second user account. By way of example, the queue may only be populated with media files on the second device that the second user account has stored on their device and/or the second user may be given the option to purchase from a third party media which the user does not have access.

Synchronization rules may be established and applied in regards to synchronization of settings, state, and data. Rules may be based on a user preference for a device, a type of device, a location for a device, a type of media recording, stored data, and/or any other criteria. For example, synchronization may be performed at a time when a user is most likely to switch from using a web application on a device in their home to using a web application on a device in their car. In another example, volume settings may be adjusted from the synchronized stored data settings in accordance with the time of day and/or preferences of the user stored for the particular time and/or device.

FIG. 2B is an exemplary flowchart for a music box in accordance with some embodiments of the invention. Flowchart 201 describes a media player, in particular, sending content items and/or metadata for content items to be cached on a device based on locally stored media player data (e.g., in regards to presentation and/or playback of media) stored on another device. Locally stored media player data on a device setting, a media player setting, and a media player state may be obtained (203). The media player data may be stored in a data store of a content management system for a first account (205). Locally stored media player data may be obtained and stored similar to steps (202) and (204), as described with FIG. 2A.

Based on media player data, at least a portion of a content item may be selectively sent to a second device associated with the first account to be cached (207). The media content item, metadata associated with the content item, and/or updates to currently cached content items may be sent to the second device. The media player data may offer insight and/or guidance as to which content items may be desired on other devices associated with the first account and a priority for caching of the content items. For example, media player data may provide information on content items and/or content item metadata recently viewed and/or present within a queue, and the content items may be preemptively cached in anticipation of being desired on devices associated with the first account. In another example, all content items from an album and/or a collection of content items may be preemptively cached, when at least one content item from the collection is present in the queue or has been accessed or viewed.

In yet another example, content items indicated as accessed while the media player was used offline and/or online as provided in logs and/or indicated with the queue for a media player may also be preemptively cached. Continuing with the example, upon entry to a location with a network, the logs may be obtained, and the logs may indicate content items and/or metadata for content items that were accessed and the content items/metadata may be preemptively cached on devices associated with the accounts. Devices may be associated with the account if the device is registered with the content management system for use with the account, if the device was used to access services of the content management system with the account, and/or any other method or mechanism to designate the device as associated with the account.

Any conditions and/or rules may be applied to determine whether content items identified as potential content items to cache using media player data are desirable to cache. Conditions and rules may be based on accessibility to networks by devices, preferences of user, statistics on prior use of particular device, weights on considering media player data, and/or any other rules for determining content items to cache. For example, content items that have not been accessed within the queue on a first device may be preemptively cached on all devices associated with an account and with access to a network connection. In some embodiments, content items may be cached on devices associated with an account, when the particular device has moved into range of a wireless network. By way of example, when the content management system detects that the device has access to the wireless network, then the content items selected for preemptive caching may be sent to the device.

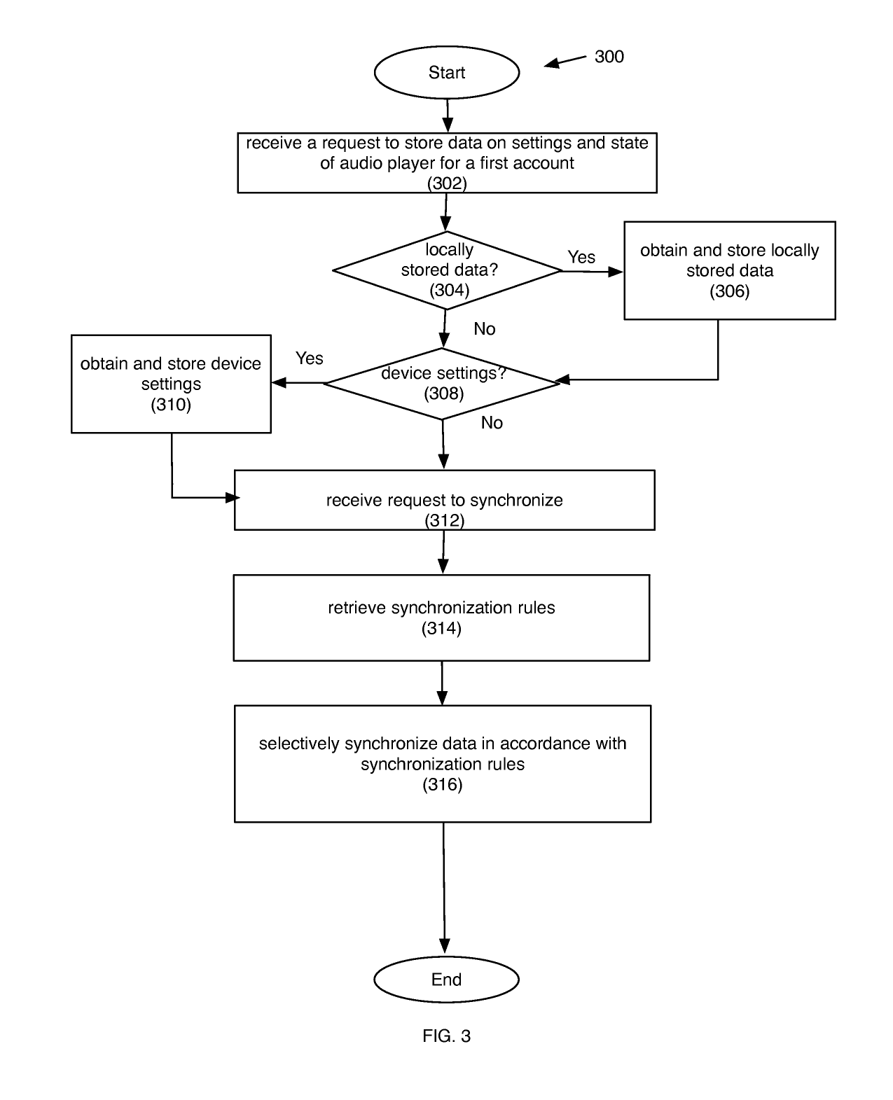

FIG. 3 is an exemplary flowchart for a music box in accordance with some embodiments of the invention. Flowchart 300 illustrates exemplary steps involved in synchronizing locally stored data between devices. A request may be received to store data on settings and state of an audio player for a first account (302). The request may be sent by the user (e.g., explicit request for synchronization or sharing), at the close of an application and/or logging off an account, and/or upon any other request for settings and state for the audio player. For example, the content management system 100 may request for the status of the media player and periodically record settings and state of the media player. If the data is locally stored (304), then such data is obtained and stored in a data store of the content management system (306). Next, if there are device settings (308), then they may be obtained and stored in the data store (310).

A request may be received to synchronize data (312), upon which synchronization rules may be retrieved (314). Stored data may be retrieved and synchronization may proceed in accordance with such synchronization rules. Synchronization rules may be defined for a user account by time, device, media type, location, and/or any other criteria. For example, synchronization rules may be specified by time for a particular mobile device, such as the synchronization rules may specify that a volume may not exceed a particular level at a particular time. Examples of synchronization rules are, as follows:
(i) Synchronize volume between tablet device and mobile device.
(ii) At location defined as home, reduce volume by 0.2 after 10:00 pm with synchronization.
(iii) Synchronize media files in queue first.
(iv) Synchronize only files on mobile1 (e.g., a particular device identifier) that have a modification to the media file.
(v) Do not synchronize data when mobile data plan is not supported or wireless connection is not available.

Finally, data may be selectively synchronized on the second device in accordance with the synchronization rules (316). The synchronization rules may also indicate what data is synchronized. For example, locally stored data may not be synchronized and/or pushed to a given mobile device for a user account, such as when battery life and/or data transmission costs are of concern for a user with a mobile device. As shown with rule (iv), a user may only desire to synchronize files on a mobile device when there has been a modification to the file. The user may rely on content management system to discover files on a mobile when there has been a modification to a location of a file within a file system hierarchy of another device and the user does not want the file system storage structure replicated on a device. In another example, a user may request (e.g., rule (v)) that data not be pushed to the mobile device when the user is located overseas because the data plan may not be supported and the user may want to ensure that there are no excessive costs with the use of a data plan overseas.

A user may select from a set of experiences with devices represented with locally stored data for a particular account and/or shared with the account. Furthermore, the content management system may provide the user of an account with the option to resume an experience on the particular device that was saved. Information from each set of stored local data may be displayed for the user to select an experience. Selection of a particular experience represented with stored local data may dictate or guide the synchronization and/or timing for the synchronization of data. For example, media files that have been modified or may not exist in local storage on the device but are in the current queue according to the local storage being replicated on the device, then the modified and/or new media files may be prioritized before other media files for synchronization. In another example, if a similar and/or related media file to a particular media file within the queue exists on the device (e.g., an earlier revision of the media file and/or the same media file in another location), then the user may be prompted as to whether to synchronize the media files.

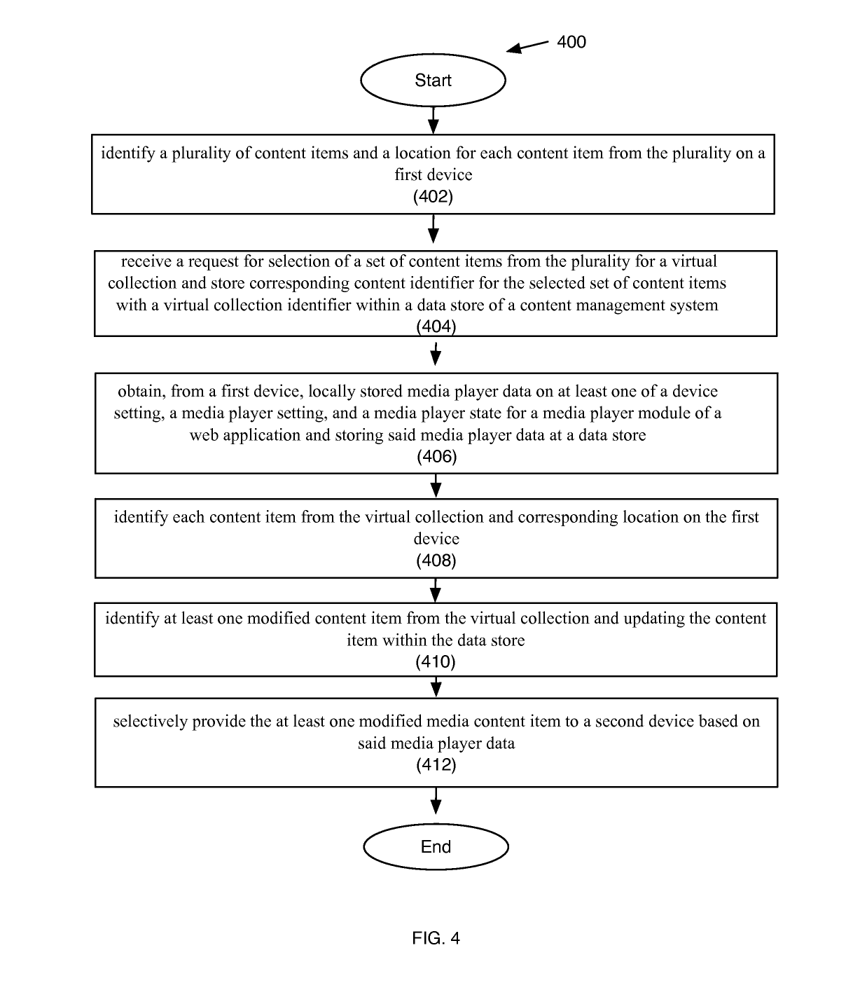

FIG. 4 illustrates an exemplary flowchart for a music box in accordance with some embodiments of the invention. Flowchart 400 illustrates steps for caching data and/or synchronizing data for a collection based on media player data. A plurality of media content items and a location for each media content item from the plurality may be identified on a first device (402). The plurality of media content items may be identified within a file system hierarchy, a database, a data store, and/or any other data collection, and the locations for storage of each of the content items may be recorded. By way of example, media files may be identified within any directory of the file system on the device and/or stored remotely in the data store for the account. For example, voicemail messages stored remotely in a database and/or cached on the device, audio files stored in a music folder/directory, video files stored in a video folder/directory, audio messages saved locally to the device, and/or any other media content items may be identified in any directory within the file system accessible with an operating system interface, a file system interface, and/or available to the account remotely.

Identification or discovery of media content items is not limited to files located/stored within a particular directory on a device. The content items may be identified throughout the file system hierarchy on a device that may be accessed by the content management system 100, such as by virtue of the operating system interface and/or file system interface. Content items may be identified as media content items based upon the file extension, the location of content item, the application associated and/or used to open the content item, and/or the metadata associated with the content item. Media content items may be identified based on having particular attributes (e.g., ID3 tags) for a type of media content item. By way of example, a media file may have an album attribute, a title attribute, a cover image, and an artist attribute that allows the media content item to be identified.

Each newly identified media content item may be assigned a content identifier and the location of the content item may be associated with the identifier in the data store. Content items that have previously been assigned a content identifier may be identified using that content identifier, and as such, any change in location of the content item (e.g., file) and/or modification to the content item may be determined for the identified file by comparing the file and/or the location to a previously stored file and location. The identified plurality of content items may be provided for display on a user interface to allow the user to interact with the content items.

A set of media content items from the plurality may be selected for a virtual collection and corresponding content identifiers for the selected set of content items may be stored with a virtual collection identifier within a data store (118 in FIG. 1) of a content management system (404). A user may select content items for the virtual collection via the user interface. The content identifiers for media content items may be grouped together to form the virtual collection regardless of their location within storage (e.g., the file system hierarchy or available remotely using the content management system). Examples of virtual collections are described in U.S. Provisional Application No. 61/750,791, entitled “Presenting Content Items Using a Collections View,” filed on Jan. 9, 2013, which is hereby incorporated by reference in its entirety. The user may interact with the collection using the media player. For example, a virtual collection may serve as a playlist of content items and the user may request the virtual collection content items be put in the queue. In another example, a subset of content items from the virtual collection may be placed in the queue.

Locally stored media player data on at least one of a device setting, a media player setting, and a media player state for a media player module of a web application from a first device may be obtained and stored at a data store (406). Locally stored media player data indicative of an experience with a media player may be obtained, and in particular, the data may be indicative of interactions with virtual collections. The media player data may be used to provide guidance for synchronizing collections and/or caching collections and modified content items of virtual collections. For example, locally stored data on customized views (e.g., filters on content items of a virtual collection, ordered content items within a view of content items), logs of events for the media player while the player was online and/or offline, and the queue on content items within a queue may provide guidance on which virtual collections and/or content items are more likely to be accessed from and desired on other devices for an account and/or for collections shared with other accounts. In some embodiments, media player data may provide a priority order for caching and/or synchronizing content items and/or collections. For example, collections of content items within a queue and/or content items that are part of a collection and are within a queue may allow for updates to the respective collection contents to be prioritized for caching and/or synchronization over other content items/collections.

At least one modified media content item from the virtual collection may be identified and updated within the data store by associating a modified location within the file system hierarchy and/or a modification to a media content item may be associated with a content identifier for the at least one modified media file in the data store (408). A user may modify a collection (e.g., add or delete a content item) and/or a content item within a collection when interacting with the media player. The modifications may be identified and stored within the data store. The content management system may identify and capture the modifications at the time of the modification, when the device has a network connection, when the device has a particular network connection (e.g., wireless network connection), and/or at any other scheduled times.

A pointer to a modified media file, a difference between files, an updated filepath for a location within a file system hierarchy, and/or any other provision of a modification to a content item or a location may be stored with the content identifier to reflect the modification. Examples of storing modified locations in a data store are provided in U.S. patent application Ser. No. 13/725,861, entitled “Preserving Content Item Collection Data Across Interfaces,” filed Dec. 21, 2012, which is herein incorporated by reference in its entirety. A difference may between the files may be stored in lieu of a pointer to the entire file. Examples of creating differences between image files that may be stored are provided in U.S. patent application Ser. No. 13/800,101, entitled “Batch Compression of Photos,” filed Mar. 13, 2013, which is herein by reference in its entirety.

The at least one modified media content item on a second device may be selectively provided based on the media player data (410). The modified content item for the virtual collection may be provided to a second device by synchronizing the content items stored on devices and/or preemptively caching the modified content item. As indicated above, obtained locally stored media player data from a first device regarding at least one of: (i) a device setting, (ii) a media player setting, and (iii) a media player state of a media player module of a web application, may be used as a guide for synchronizing/caching the at least one modified content item. For example, if the content item or collection is in a queue, then the modified content item may be synchronized, or the modified content item and/or the collection containing the modified content item may be pre-emptively cached. In some cases, the collection may have already been cached and sending the modified content item to be cached may be preferred. Examples of synchronization of collection data are provided in U.S. patent application Ser. No. 13/725,861, entitled “Preserving Content Item Collection Data Across Interfaces,” filed Dec. 21, 2012, and is incorporated herein by reference in its entirety. Continuing with the example, the presence in the queue of the content item may provide guidance for prioritizing content items for synchronization and/or caching of collections and modifications to collections.

The order of content items within the queue may further provide guidance on how to order synchronization/caching of content items and collections. For example, content items may be cached/synchronized in the same order found in the queue for playback. In another example, the log events for offline use of the media player may provide guidance on favored content items and/or collections that are frequently accessed by the user and content items/collections may be cached in accordance with events logged for the media player.

In some embodiments, a user may request to display an ordered or a filtered view of the plurality of media files of the virtual collection and corresponding links within the user interface may be received. The user may select ordering of files that differs from the storage of the files within a file system hierarchy and/or stored with the content management system 100. For example, the user may filter media files to be ordered by album name, artist name, a user selected ordering, date, and/or any other sorted ordering. In another example, user may select media files to be ordered as desired, such as grouping media files based upon events (e.g., spring vacation music), type of music, and/or any other particular order that the user wants the music displayed. The sort order may be stored locally as transient data and may be used to indicate a priority for caching and/or synchronizing content items.

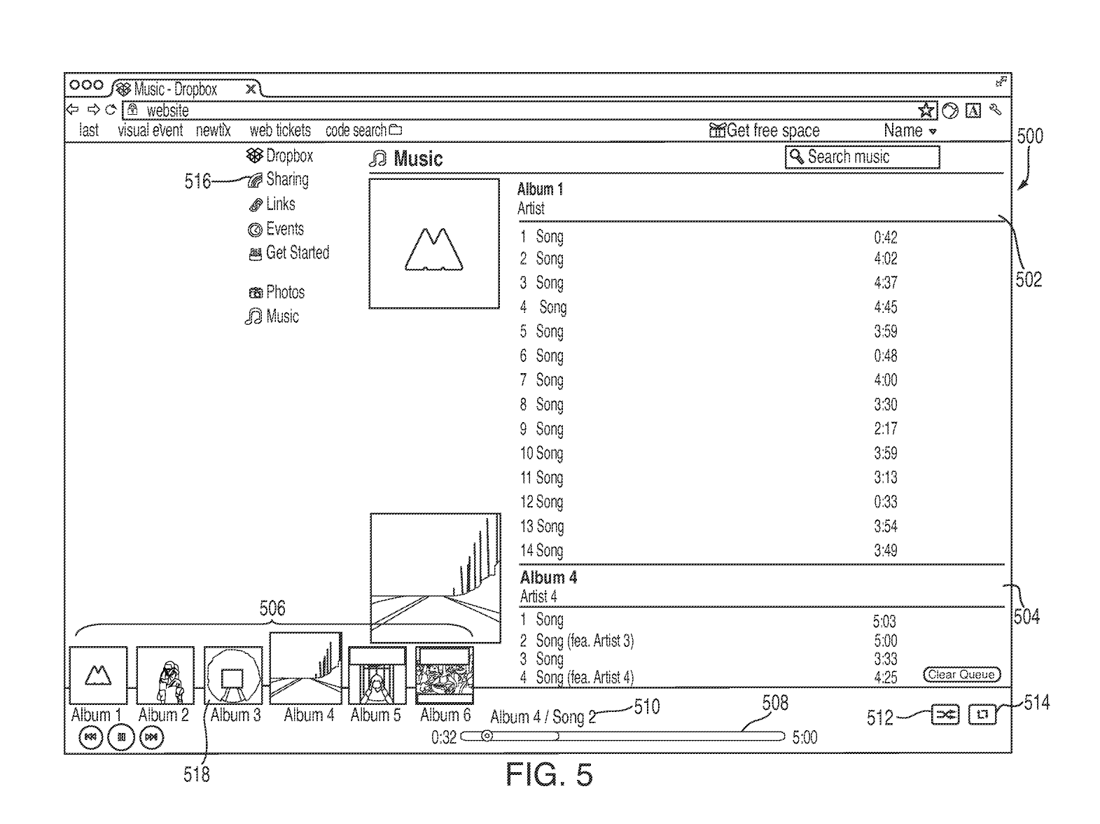

FIG. 5 is an exemplary user interface for a music box in accordance with some embodiments of the invention. User interface 500 may be generated by a web application and displayed within a browser. User interface 500 illustrates an ordered view of media files 502 and 504, and a queue 506 of media files for use with media player 508. A user has selected to order “Album 4” 504 immediately following “Album 1” 502, and not to use a “natural” sequential order with “Album 2” following “Album 1.” The albums may be located anywhere within the file system hierarchy on a first device. User controls for shuffle 512 and continuous play 514 are provided for the media player 508.

As illustrated with a larger visual representation 518 within queue 506, a song from “Album 4” 504 is playing, and is at time “0:16” of the song. State for the media player, including position in the queue 506 and song selected for playback, may be recorded. Shuffle 512 and continuous play 514 settings may be stored in local storage on the first device. The state and settings may be optionally synchronized and/or shared (e.g., with user control 516), and reproduced on another device.

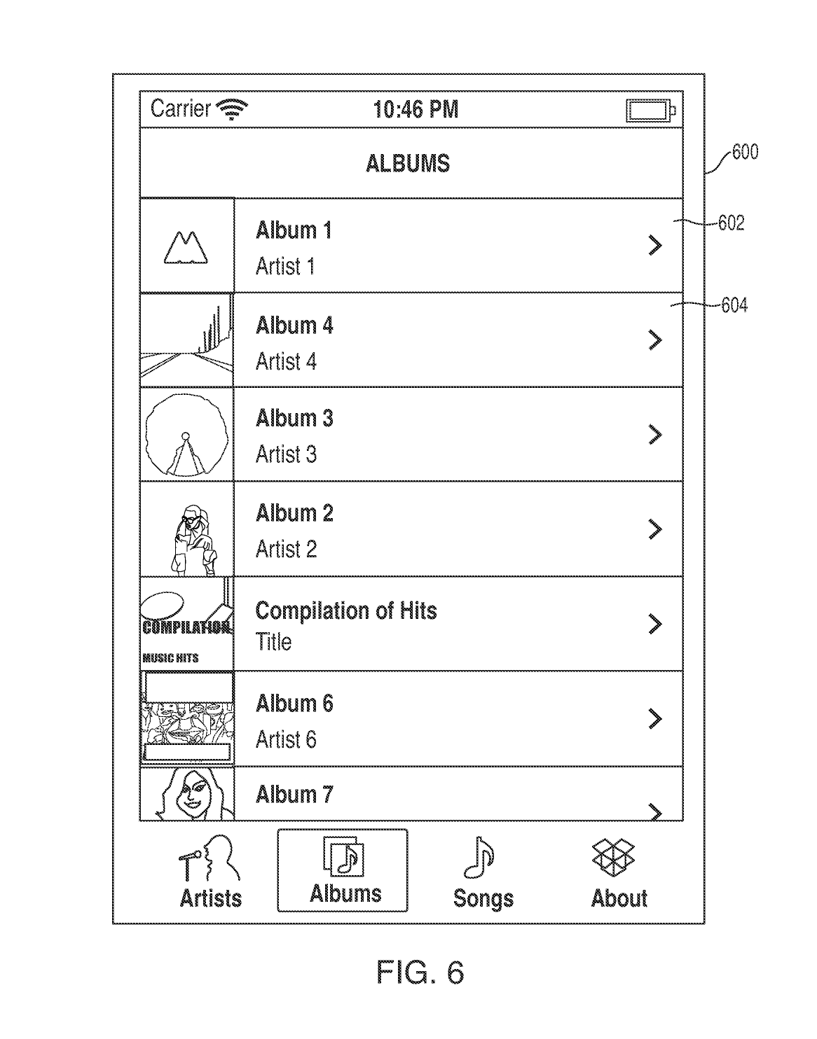

FIG. 6 is an exemplary user interface for a music box in accordance with some embodiments of the invention. User interface 600 is an example of a user interface for a mobile device. As shown in FIG. 6, an order provided in user interface 500 is preserved from the user interface in first device 500 with “Album 4” 604 ordered just after “Album 1” 602. Locally stored data and/or data pulled from content management system 100 may be used to ensure that the same ordered view is provided in the user interface.

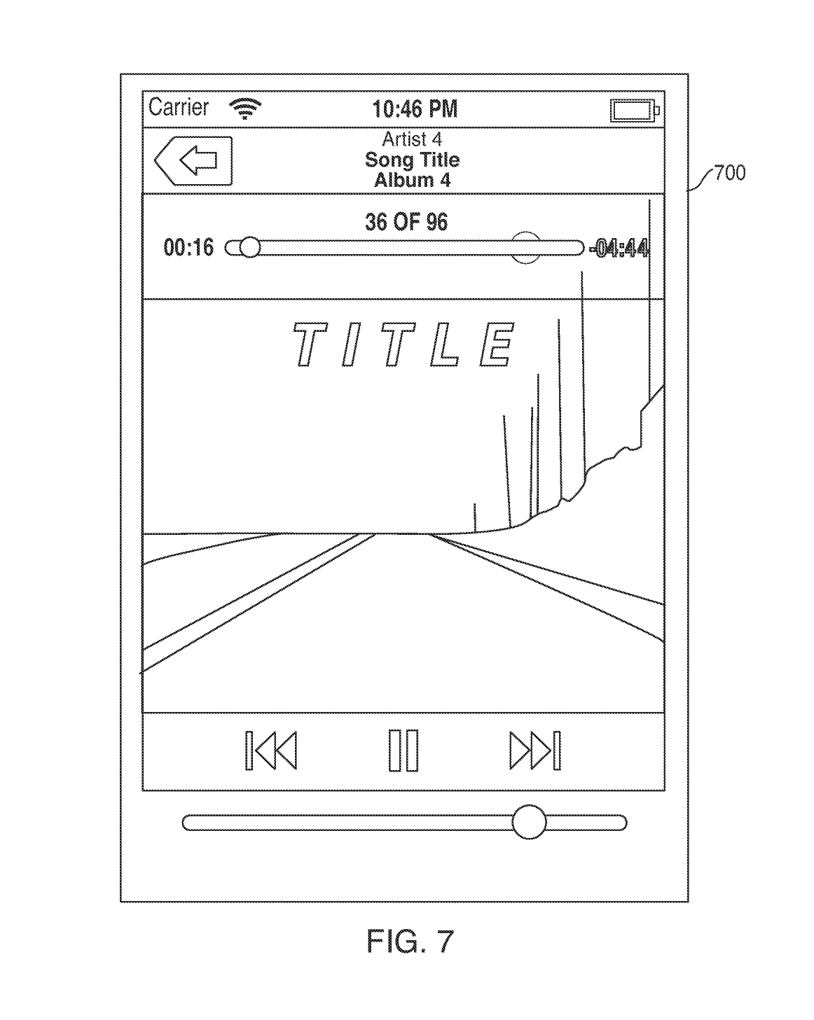

FIG. 7 is an exemplary user interface for a music box in accordance with some embodiments of the invention. User interface 700 provides another example of a mobile application. As shown in FIG. 7, when a user moves from first device 102a (see FIG. 1) using an exemplary web application to second device 102b (see FIG. 1), the playback position in queue, and within the media file, may be preserved to continue the user experience on second device 102b.

Exemplary Implementations

Any suitable programming language can be used to implement the routines of particular embodiments including, but not limited to, the following: C, C++, Java, JavaScript, Python, Ruby, CoffeeScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time

Particular embodiments may be implemented in a computer-readable storage device or non-transitory computer readable medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium, such as a storage device, to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While there have been described methods for music box thereof, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

What is claimed is:

1. A method, comprising:
obtaining, from a first device, locally stored media player data on at least one of a device setting, a media player setting, and a media player state of a media player module of a web application;
storing the media player data in a data store of a content management system for a first account; and
selectively synchronizing, based on the media player data, locally stored data on a second device associated with the first account to provide a continued experience with media on the second device.

2. The method of claim 1, wherein synchronizing comprises updating content items at two or more locations to ensure that the content items are identical.

3. The method of claim 1, wherein the media player data comprises at least one of a volume setting, a treble setting, a position within a media file, a position within a queue of media files, a queue of media files, a selected playlist, an equalization setting, a cross fade setting, a playhead, a sort order, a shuffle setting, a beats per minute calculation for a content item, a search query on content items, a set of selected content items for a view, and a log for execution of the media player module.

4. The method of claim 1, further comprising:
sharing the media player data with a second account and selectively synchronizing the media player data with locally stored media player data on a device associated with the second account to allow for at least one of: (1) continued execution of media and (2) presentation of media as established for the first account.

5. The method of claim 1, further comprising:
obtaining the media player data from at least one of a file stored locally on the first device, a cache on the first device, a file with HTML5 local stored data on the first device, a file with session data on the first device, and a log for execution of the media player; and
obtaining a device setting using at least one of an operating system interface and a device interface.

6. The method of claim 1, further comprising:
retrieving synchronization rules for the second device, wherein the rules are based on at least one of a user preference for a device, a type of device, a time of day, a location, and a type of media recording; and
selectively synchronizing the locally stored data on the second device in accordance with the rules.

7. The method of claim 1, wherein the media player data comprises transient locally stored data for a client application on the first device.

8. The method of claim 1, further comprising:
selectively synchronizing content items stored on the first device with the second device based upon a queue of music indicated in the media player data.

9. The method of claim 1, further comprising:
identifying a plurality of media content items for a virtual collection and a location for each media content item from the plurality within a file system hierarchy on the first device;
identifying at least one modified media content item from the plurality and updating at a data store by associating with a content identifier for the at least one modified media content item at least one of: (1) a modified location within the file system hierarchy and (2) a modification to a media content item; and
selectively providing the at least one modified media content item on a second device based on the media player data.

10. The method of claim 9, wherein selectively providing comprises at least one of: (1) caching the at least one modified media content item, and (2) synchronizing the at least one modified media content item stored locally on the second device based on updates to the media content item.

11. A method, comprising:
obtaining, from a first device, locally stored media player data on a media player state of a media player module of a web application;
storing the media player data in a data store of a content management system for a first account; and
selectively providing at least a portion of a content item to a second device associated with the first account to synchronize cached data based on the media player data.

12. The method of claim 11, wherein the media player data comprises transient locally stored data for a client application on the first device.

13. The method of claim 11, wherein the media player data comprises at least one of a position within a media file, a position within a queue of media files, a queue of media files, a selected playlist, a playhead, a sort order for a virtual collection view, a shuffle setting, and a log for execution of the media player module.

14. A non-transitory computer readable medium containing instructions that, when executed by at least one processor of a computing device, cause the computing device to:
obtain, from a first device, locally stored media player data on at least one of a device setting, a media player setting, and a media player state of a media player module of a web application;
store the data in a data store of a content management system for a first account; and
selectively synchronize, based on the media player data, locally stored data on a second device associated with the first account to provide a continued experience with media on the second device.

15. The non-transitory computer readable medium of claim 14, wherein the media player data comprises at least one of a volume setting, a treble setting, a position within a media file, a position within a queue of media files, a queue of media files, a selected playlist, an equalization setting, a cross fade setting, a playhead, a sort order, a shuffle setting, a beats per minute calculation for a content item, a search query on content items, a set of selected content items for a view, and a log for execution of the media player module.

16. The non-transitory computer readable medium of claim 14, wherein the computing device is further caused to:
share the media player data with a second account and selectively synchronizing the media player data with locally stored media player data on a device associated with the second account to allow for at least one of (1) continued execution of media and (2) presentation of media as established for the first account.

17. The non-transitory computer readable medium of claim 14, wherein the computing device is further caused to:
obtain the media player data from at least one of a file stored locally on the first device, a cache on the first device, a file with HTML5 local stored data on the first device, a file with session data on the first device, and a log for execution of the media player; and
obtain a device setting using at least one of an operating system interface and a device interface.

18. The non-transitory computer readable medium of claim 14, wherein the computing device is further caused to:
retrieve synchronization rules for the second device, wherein the rules are based on at least one of a user preference for a device, a type of device, a time of day, a location, and a type of media recording; and
selectively synchronize the locally stored data on the second device in accordance with the rules.

19. The non-transitory computer readable medium of claim 14, wherein the media player data comprises transient locally stored data for a client application on the first device.

20. The non-transitory computer readable medium of claim 14, wherein the computing device is further caused to: selectively synchronize content items stored on the first device with the second device based upon a queue of music indicated in the media player data.

21. The non-transitory computer readable medium of claim 14, wherein the computing device is further caused to:
identify a plurality of media content items for a virtual collection and a location for each media content item from the plurality within a file system hierarchy on the first device;
identify at least one modified media content item from the plurality and updating at a data store by associating with a content identifier for the at least one modified media content item at least one of: (1) a modified location within the file system hierarchy, and (2) a modification to a media content item; and
selectively provide the at least one modified media content item on a second device based on the media player data.

22. The non-transitory computer readable medium of claim 21, wherein selectively providing comprises at least one of: (1) caching the at least one modified media content item, and (2) synchronizing the at least one modified media content item stored locally on the second device based on updates to the media content item.

23. A non-transitory computer readable medium containing instructions that, when executed by at least one processor of a computing device, cause the computing device to:
obtain, from a first device, locally stored media player data on a media player state of a media player module of a web application;
store the media player data in a data store of a content management system for a first account; and
selectively provide at least a portion of a content item to a second device associated with the first account to synchronize cached data based on the media player data.

24. The non-transitory computer readable medium of claim 23, wherein the media player data comprises transient locally stored data for a client application on the first device.

25. The non-transitory computer readable medium of claim 23, wherein the media player data comprises at least one of a position within a media file, a position within a queue of media files, a queue of media files, a selected playlist, a playhead, a sort order for a virtual collection view, a shuffle setting, and a log for execution of the media player module.

26. A system, the system comprising:
one or more processors; and
memory containing instructions that, when executed, cause one or more processors to:
obtain, from a first device, locally stored media player data on at least one of a device setting, a media player setting, and a media player state of a media player module of a web application;
store the data in a data store of a content management system for a first account; and
selectively synchronize, based on the media player data, locally stored data on a second device associated with the first account to provide a continued experience with media on the second device.

27. A system, the system comprising:
one or more processors; and
memory containing instructions that, when executed, cause one or more processors to: obtain, from a first device, locally stored media player data on a media player state of a media player module of a web application;
store the media player data in a data store of a content management system for a first account; and
selectively provide at least a portion of a content item to a second device associated with the first account to synchronize cached data based on the media player data.
